(19) United States
(12) Patent Application Publication
(10) Pub. No.: US 2025/0315677 A1
(43) Pub. Date: Oct. 9, 2025

(54) MEMORY EFFICIENT NEURAL NETWORK TRAINING METHOD AND SYSTEM

(71) Applicant: Royal Bank of Canada, Toronto (CA)

(72) Inventors: Yongchang HAO, Edmonton (CA); Yanshuai CAO, Toronto (CA); Lili MOU, Edmonton (CA)

(21) Appl. No.: 19/043,279

(22) Filed: Jan. 31, 2025

Related U.S. Application Data
(60) Provisional application No. 63/631,836, filed on Apr. 9, 2024.

(51) Int. Cl. G06N 3/084

(52) U.S. Cl. CPC G06N 3/084

(57) ABSTRACT

A memory efficient neural network training method and system. A forward pass is performed by inputting a batch of training data to a neural network. A loss is determined from an output of the neural network resulting from the forward pass, and back propagation is performed as part of the training on the neural network. Performing the back propagation involves, for each layer of the neural network, determining a gradient or optimizer state for the layer of the neural network, and compressing the gradient or optimizer state by performing a random down-projection on the gradient. Following determining and down projecting the gradients or optimizer states for the layers of the neural network, the gradients or optimizer states based on the gradients are decompressed, and the weights of the neural network are updated based on the decompressed gradients or optimizer states. A different random down-projection is used for each layer.

### CROSS-REFERENCE TO RELATED APPLICATIONS

The present application claims priority to U.S. provisional application No. 63/631,836 filed on Apr. 9, 2024, and entitled “Memory Efficient Neural Network Training Method and System”, the entirety of which is hereby incorporated by reference herein.

### TECHNICAL FIELD

The present disclosure is directed at methods, systems, and techniques for training neural networks, such as transformers, in a memory efficient manner.

### BACKGROUND

Gradient-based optimization powers the learning part of deep neural networks. In its simplest form, stochastic gradient descent (“SGD”) updates model parameters using noisy estimation of the negative gradient. More advanced methods track various gradient statistics to stabilize and accelerate training [12, 16]. For example, the momentum technique tracks an exponential moving average of gradients for variance reduction [6] and damping [15]. On the other hand, gradient accumulation computes the average of gradients in the last few batches to simulate a larger effective batch for variance reduction [45]. Both cases require an additional memory buffer equal to the model size to store information.

However, such a linear space complexity of optimization states becomes problematic in modern deep learning. For example, the GPT-3™ [3] and Stable DiffusionT [41] networks are trained with the Adam™ optimizer [20] where momentum is applied. For each scalar in the parameter set, the Adam™ optimizer maintains two additional variables (i.e., first- and second-moment estimates), tripling the memory usage. The largest GPT-3™ network, for example, has 175 billion parameters taking 700 GB of memory. The Adam™ optimizer requires an additional 1.4 TB memory for optimization states. This excessive amount of memory usage poses a scaling challenge.

One line of research saves memory by training a subset of parameters [17, 48], so the optimizer only stores information about a small set of trainable parameters. One notable example is the low-rank adaptation (“LoRA”) [18]. LoRA updates parameter matrices by low-rank patches, which contain much fewer trainable parameters. In this way, the momentum and gradient accumulation also have much smaller sizes. However, LoRA restricts the weight update to be in the low-rank form, limiting the optimization space of the model parameters.

Another line of work designs new optimizers that use less memory [10, 13]. For instance, the Adafactor™ optimizer [42] leverages the closed-form solution of generalized Kullback-Leibler divergence [14] to reconstruct the second-moment estimate in the Adam™ optimizer. To optimize a matrix in [symbol] ^{n×m}, the Adafactor™ optimizer reduces the requisite memory from O(nm) to O(n+m), making the space complexity of second-moment estimation sublinear in model size. However, the Adafactor™ optimizer drops the momentum technique to achieve the sublinearity, sacrificing the variance reduction and damping effect of momentum [39]. Moreover, it does not reduce the memory for gradient accumulation.

### SUMMARY

According to a first aspect, there is provided a memory efficient neural network training method. The method comprises performing a forward pass by inputting a batch of training data to a neural network; determining a loss from an output of the neural network resulting from the forward pass; and performing back propagation on the neural network. Performing the back propagation comprises, for each layer of the neural network, determining a gradient (or optimizer state) for the layer of the neural network; and compressing the gradient (or optimizer state) by performing a random down-projection on the gradient. Following determining and down projecting the gradients for the layers of the neural network, the gradients (or optimizer states) based on the gradients are decompressed, and the weights of the neural network are updated based on the decompressed gradients (or optimizer states). A different random down-projections is used for each layer of the neural network during the back propagation. More particularly, in at least some aspects, any one or more of the following may apply:
(a) For decompression, a transpose of a random projection matrix used during compression is applied. This may be done without storing the projection matrix explicitly, which would cost memory. Instead, the random seed corresponding to the random projection matrix may be kept in memory, and that random seed may be used to generate (or re-generate) the projection matrix or its transpose on the fly. Alternatively, the random projection matrix itself may be kept in memory if a different time/memory trade-off is desired.
(b) Between down projecting for compression and up projecting for decompression, the method may further comprise determining and accumulating statistics related to the compressed gradient. These statistics may correspond, for example, to gradient accumulation and/or momentum.
(c) Updating of the weights may be performed on a per layer basis.

According to another aspect, there is provided a memory efficient neural network training method, the method comprising: performing a forward pass by inputting a batch of training data to a neural network; determining a loss from an output of the neural network resulting from the forward pass; and performing back propagation on the neural network, wherein performing the back propagation comprises: for each layer of the neural network: determining a gradient and/or optimizer state for the layer of the neural network; and compressing the gradient and/or optimizer state by performing a random down-projection on the gradient; following determining and down projecting the gradients and/or optimizer states for the layers of the neural network, decompressing the gradients and/or optimizer states based on the gradients; and updating weights of the neural network based on the decompressed gradients and/or optimizer states, wherein a different random down-projection is used for each layer during the back propagation.

Updating of the weights may be performed on a per layer basis.

The gradient may be determined for each layer.

The optimizer state may be determined for each layer.

The optimizer state may be momentum.

The random down-projection may be performed using a fixed random projection matrix, and the fixed random projection matrix may be resampled during the training.

The fixed random projection matrix may be resampled each time the compressing is performed.

The gradient or optimizer state may be averaged over the layers, and the average of the gradient or optimizer state may be used to update the weights.

The average may be an arithmetic mean.

The gradient may be an accumulated gradient comprising the gradient for multiple layers, the decompressing may comprise determining a mean of the accumulated gradient, and the mean of the accumulated gradient may be used to update the weights.

The average may be an exponential moving average.

The optimizer state may be momentum that is averaged over multiple layers, the decompressing may comprise decompressing the exponential moving average of the momentum, and the averaged momentum may be used to update the weights.

The random down-projection may be performed using a fixed random projection matrix, and the fixed random projection matrix may be resampled during the training at a rate lower than for each layer.

The training may be performed over a series of time steps, and the compressed exponential moving average of the momentum for a given one of the time steps may be determined from the compressed exponential moving average of the momentum for a prior one of the time steps multiplied by the random projection matrix and a transpose of the random projection matrix.

The random down-projection may be performed using a fixed random projection matrix, and a random seed that generates the fixed random projection matrix may be stored across batches in lieu of the fixed random projection matrix.

According to another aspect, there is provided a system for memory efficient neural network training, the system comprising: at least one database having stored thereon at least one batch of training data; at least one processing unit communicatively coupled to the at least one database and configured to perform the above memory efficient neural network training method.

According to another aspect, there is provided at least one non-transitory computer readable medium having encoded thereon computer program code that is executable by at least one processor and that, when executed by the at least one processor, causes the at least one processor to perform above the memory efficient neural network training method.

This summary does not necessarily describe the entire scope of all aspects. Other aspects, features and advantages will be apparent to those of ordinary skill in the art upon review of the following description of specific embodiments.

### BRIEF DESCRIPTION OF THE FIGURES

In the accompanying drawings, which illustrate one or more example embodiments:

FIG. 1 depicts performance of a low-rank adaptation method, according to an example embodiment.

FIGS. 2A and 2B depict memory usage when applying a method for memory efficient neural network training according to two different batch sizes of training data, according to an example embodiment.

FIGS. 3A to 3C depict memory usage using three different methods for neural network training, with FIG. 3C showing memory usage when applying a method for memory efficient neural network training according to an example embodiment.

FIGS. 4A to 4C depict memory usage using three different methods for neural network training respectively corresponding to the methods of FIGS. 3A to 3C, each in combination with a low memory optimization method, according to an example embodiment.

FIG. 5 depicts a computer system that may be used to implement a method for memory efficient neural network training, according to an example embodiment.

### DETAILED DESCRIPTION

The present disclosure is directed at an optimization technique (“Flora”) that uses sublinear memory for gradient accumulation and momentum calculation. Flora applies such a compression technique directly to the update of the original weight matrix to compress the gradient into a lower-dimensional space. More particularly, in at least some embodiments Flora resamples the random projection and is able to mitigate the low-rank limitation of LoRA. Further, in at least some embodiments Flora only stores the compressed gradient accumulation and momentum, thus saving the memory usage of optimization states (interchangeably referred to as “optimizer states” herein) to the sublinear level. Experiments were also conducted across different tasks and model architectures to verify Flora's effectiveness. When combined with Adafactor as a base optimizer, Flora yields similar performance to an uncompressed, full-matrix update, while largely outperforming other compression techniques such as LoRA. Interestingly, the space complexity of Flora is in the same order as LoRA but has a smaller constant in practice, leading to less memory usage than LoRA.

### Approach

In this section, observation of the dynamics of LoRA updates is described, followed by showing that LoRA can be approximated by random projection, which serves as gradient compression and which can be used for sublinear-space gradient accumulation and momentum calculation.

### Dynamics of Low-Rank Adaptation (LoRA)

For updating a pre-trained weight matrix W∈ [symbol] ^{n×m}, LoRA parameterizes B∈ [symbol] ^{n×r} and A∈ [symbol] ^{r×m} with r<<min{n, m}. After applying LoRA, the forward pass becomes

$$y = ( W + BA ) x = Wx + BAx , \qquad ( 1 )$$

where x∈ [symbol] ^{m} is the input for current layer and y∈ [symbol] ⁿ is the pre-activation value of the next layer. At the beginning of LoRA updates, BA should not change the original weight W. Typically the matrix B is initialized with an all-zero matrix and A with a normal distribution.

During back-propagation, the matrix W has gradient

$${∇}_{W} ℒ = \frac{\partial L}{\partial y} {x}^{T} , \qquad ( 2 )$$

where

$$\frac{\partial L}{\partial y} ∈ {ℝ}^{n}$$

is the partial derivative w.r.t. y. LoRA only calculates the gradient w.r.t. the matrices A and B, given by

$$\frac{\partial ℒ}{\partial A} = {B}^{T} \frac{\partial L}{\partial y} {x}^{T} = {B}^{T} ( {∇}_{W} ℒ ) \qquad ( 3 )$$

$$and$$

$$\frac{\partial ℒ}{\partial B} = \frac{\partial ℒ}{\partial y} {x}^{T} {A}^{T} = ( {∇}_{W} ℒ ) {A}^{T} . \qquad ( 4 )$$

In Equations (3) and (4), LoRA essentially down-projects the original gradient to a lower dimension. In fact, it was discovered that LoRA recovers the random projection method [8, 1]. This is expressed formally as Theorem (1):
Let LoRA update matrices A and B with SGD for every step t by

$${A}_{t + 1} ← {A}_{t} - η {B}_{t}^{T} ( {∇}_{W} {ℒ}_{t} ) \qquad ( 5 )$$

$${B}_{t + 1} ← {B}_{t} - η ( {∇}_{W} {ℒ}_{t} ) {A}_{t}^{T} . \qquad ( 6 )$$

Assuming

$${‖ {\sum }_{t = 0}^{T} {∇}_{W} {ℒ}_{t} ‖}_{F} \leq L$$

for every T during training, which implies that the model stays within a finite Euclidean ball, the dynamics of Aₜ and Bₜ are given by

$${A}_{T} = {A}_{0} + η {A}_{0} {f}_{A} ( T ) , {B}_{T} = η {f}_{B} ( T ) {A}_{0}^{T} , \qquad ( 7 )$$

where the forms of f_{A}(t)∈ [symbol] ^{m×m} and f_{B}(t)∈ [symbol] ^{n×m} are as follows:

$${f}_{A} ( t ) = - η {\sum }_{i = 0}^{t - 1} {f}_{B}^{T} ( i ) ( {∇}_{W} {ℒ}_{i} ) \qquad ( 7.1 )$$

$${f}_{B} ( t ) = - {\sum }_{i = 0}^{t - 1} ( {∇}_{W} {ℒ}_{i} ) ( η {f}_{A}^{T} ( i ) + I ) , \qquad ( 7.2 )$$

for t≥1, and where f_{A}(0)=f_{B}(0)=0 when t=0. In particular,

$${‖ {f}_{A} ( t ) ‖}_{2} \leq \frac{η {L}^{2} ( 1 - {( {η}^{2} {L}^{2} )}^{t} )}{1 - {η}^{2} {L}^{2}}$$

for every t.

Theorem (1) describes the SGD dynamics of LoRA updates. Without loss of generality, the total changes of A and B after T step are denoted as ΔA and ΔB, respectively. Then the fine-tuned forward function will be

$$\begin{matrix}W + ( {B}_{0} + Δ B ) ( {A}_{0} + Δ A ) & = & W + {B}_{0} {A}_{0} + {B}_{0} Δ A + Δ B {A}_{0} + Δ B Δ A & ( 8 ) \\ & = & W + Δ {BA}_{0} + Δ B Δ A , & ( 9 )\end{matrix}$$

where B₀=0 is due to the initialization of the B matrix. The final expression dissects the LoRA weight into two parts. It is the first part that dominates the total weight change. More particularly, when the learning rate is small,

$$W + ( {B}_{0} + Δ B ) ( {A}_{0} + Δ A ) \approx W + Δ B {A}_{0} . \qquad ( 10 )$$

This can be seen by expanding B₀ and A₀ in accordance with Theorem (1). Specifically,

$$W + Δ B {A}_{0} + Δ B Δ A = W + η {f}_{B} ( t ) {A}_{0}^{T} {A}_{0} + {η}^{2} {f}_{B} ( t ) {A}_{0}^{T} {A}_{0} {f}_{A} ( t ) \qquad ( 11 )$$

The third term has a smaller magnitude when the learning rate is not large. This is because

$${‖ {f}_{A} ( t ) ‖}_{2} \leq {‖ {f}_{A} ( t ) ‖}_{F} \leq \frac{η {L}^{2} ( 1 - {( {η}^{2} {L}^{2} )}^{t} )}{1 - {η}^{2} {L}^{2}}$$

as per Theorem (1). If η<<1/L, lim_{t→∞}η∥f_{A}(t)∥<<1, which indicates that the third term is significantly smaller than the second term, making it negligible in the final updates.

### Random Projection of Gradients

As discussed above, the change of the matrix B dominates the final weight. A simplification is to freeze the matrix A and to tune the matrix B only (denoted by Δ\tilde{B}). In this case,

$$\begin{matrix}W + ( {B}_{0} + Δ B ) ( {A}_{0} + Δ A ) & \approx & W + Δ \tilde{B} {A}_{0} & ( 12 ) \\ & \text{=:} & W + η {\tilde{f}}_{B} ( T ) {A}_{0}^{T} {A}_{0} . & ( 13 )\end{matrix}$$

In Equation (12), B₀ is dropped because B is initialized as an all-zero matrix. Equation (13) defines \tilde{f}_{B}(T), which will have the update form

$${\tilde{f}}_{B} ( t + 1 ) := {\tilde{f}}_{B} ( t ) - {∇}_{W} {ℒ}_{t} \qquad ( 14 )$$

following the derivations as per Theorem (1). Therefore, \tilde{f}_{B} (t)=−Σᵢ∇_{W} [symbol] ᵢ. Putting it to Equation (13),

[symbol]

$$W + η {\tilde{f}}_{B} ( T ) {A}_{0}^{T} {A}_{0} = W - η ( {\sum }_{t = 0}^{T} {∇}_{W} {ℒ}_{t} ) {A}_{0}^{T} {A}_{0} = W - η {\sum }_{t = 0}^{T} [ ( {∇}_{W} {ℒ}_{t} ) {A}_{0}^{T} {A}_{0} ] . \qquad ( 15 )$$

In other words, the foregoing analysis reveals that, with some approximations, LoRA updates can be viewed as performing random projection to the gradient. In particular, it compresses a gradient by a random down-projection A₀^{T}, and then decompresses it by an up-projection A₀.

### Interpreting LoRA

As mentioned above, in view of the foregoing analysis, LoRA may be framed as the compression and decompression of gradients.

LoRA first compresses the gradient by a random down-projection, which can be justified by the following result based on the Johnson-Lindenstrauss lemma [7, 32]:
Let ϵ∈(0,1/2] and δ∈(0,1). Let A∈ [symbol] ^{r×m} be a random matrix where each element [symbol] is independently sampled from a standard Gaussian distribution. There exists a constant c such that when r=cϵ⁻² log(δ/2),

$$( 1 - ϵ ) ‖ x ‖ \leq ( 1 / \sqrt{r} ) ‖ Ax ‖ \leq ( 1 + ϵ ) ‖ x ‖ \qquad ( 16 )$$

with probability at least 1−δ for every x∈ [symbol] ^{m}.

Essentially, this lemma suggests that, with a high probability, the projection by a random Gaussian matrix largely preserves the scaled norm in the original space. In the case of LoRA, such a random projection is applied to each row of the gradient matrices, whose dimension is thus reduced from [symbol] ^{n×m} to [symbol] ^{r×m}. The lemma asserts that the norm structure of the rows is approximately preserved.

After down-projection by A₀^{T}, LoRA decomposes the gradient by an up-projection A₀. This recovers the original gradient in expectation:

$${𝔼}_{{A}_{0}} [ W + ( {∇}_{W} {ℒ}_{t} ) {A}_{0}^{T} {A}_{0} ] = W + ( {∇}_{W} {ℒ}_{t} ) {𝔼}_{{A}_{0}} [ {A}_{0}^{T} {A}_{0} ] \qquad ( 17 )$$

where (1/r) [symbol] _{A}_{₀}[A₀^{T}A₀] is an identity matrix. Moreover, the larger the rank r, the closer the expectation is to the identity. The error is quantified in Theorem (2):
Let A be a matrix of shape [symbol] ^{r×m} where each element is independently sampled from a standard Gaussian distribution. Let ϵ, δ∈(0,1]. There exists a constant c such that when r=c log(2m/δ)ϵ⁻², for all i,j

$$\vert {[ {A}^{T} A - l ]}_{l , j} \vert \leq ϵ \qquad ( 18 )$$

with confidence at least 1−δ.

Theorem (2) implies that r only needs to scale logarithmically to preserve the element-wise reconstruction error, which is efficient in both computation and memory. Further, the logarithmic asymptotic rate makes it an ideal candidate to be applied to the training of modem neural models where m is large.

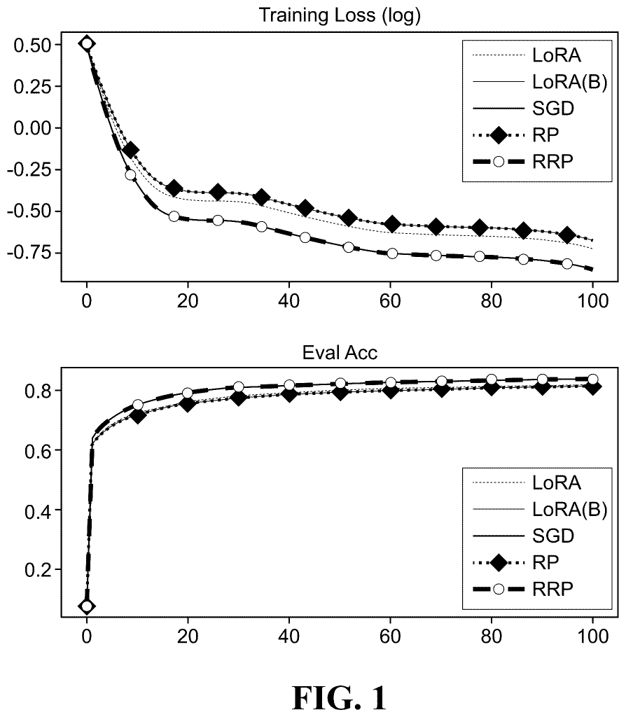

The above interpretation of LoRA was experimentally verified by a pilot study on the Fashion-MNIST dataset [47] with a simple feed-forward network. A variant of LoRA where only B is tuned was used; this variant is referred to as “LoRA(B)”. As shown in FIG. 1, the performance of LoRA(B) is close to the original LoRA, which is consistent with the discussion above in respect of Equations (10) and (11) and suggests the overall update of LoRA is dominated by the compression-and-decompression step. Further, the curve is identical to random projection (RP), well aligned with Equation (15). More particularly, in FIG. 1 the LoRA patch is applied to the first layer of the network with a shape of 768×768 and set r=8. The legend LoRA is the original LoRA method, while LoRA(B) is the simplification where only the matrix B is updated. RP (random projection) and RRP (resampled RP) follow the same update rule (i.e., Equation (15)), but RRP uses different projection matrices at different steps. In addition, FIG. 1 shows the results of SGD on the full model for comparison. All experiments use the same η=0.01.

### Flora

Based on the analyses, the present disclosure is directed at embodiments of a method referred to as “Flora” to enable overall high-rank updates. In at least some embodiments, Flora constantly resamples the projection matrix in Equation (15). Therefore, the total weight change is no longer constrained to be low-rank. Moreover, random-projection compression can be applied to the optimization states for memory saving. Two common scenarios are presented below: applying Flora in respect of (1) an arithmetic mean (AM) over a period of history, for which a concrete example is gradient accumulation; and (2) an exponential moving average (EMA), for which an example could be momentum calculation. It is shown that compression of Flora has the same asymptotic rate as LoRA but with a lower constant.

With the approximation in respect of Equation (11), LoRA can be viewed as having a fixed random projection matrix A₀. This restricts the overall change of W to be low-rank. However, the present disclosure holds for any random matrix at every time step.

Therefore, Flora resamples a new random matrix to avoid the total change restricted in a low-rank subspace. Experimentally, it has been found that resampling the random matrix (RRP) largely recovers the performance of full-matrix SGD, significantly surpassing both the original LoRA and its approximated version in Equation (15). The empirical evidence highlights the effectiveness of avoiding the low-rank constraint in Flora.

It should be emphasized that the down-projection matrix A in LoRA cannot be resampled. This is because A and B are coupled during the updates, and if the down-projection matrix A is resampled, the already updated matrix B will not fit. In contrast, Flora directly updates the weight matrix W during training, making it flexible to choose a random down-projection at every step.

One application of Flora is to compress the optimization states to save memory during training. This is first shown with an example of gradient accumulation, which is widely used in practice to simulate a larger batch size [44]. Specifically, it calculates the arithmetic mean (AM) of gradients for τ steps and updates the model by the AM. In this way, the effective batch size is τ times larger than the original batch size. However, it requires a memory buffer, whose size is equal to the model itself, to store the accumulated gradients.

In Flora, the gradient accumulation is compressed with the down-projection. Within an accumulation cycle, only the accumulated gradient is maintained in the randomly down-projected space. During decompression, the memory can be reused for gradients to reduce additional overheads. The resampling of the projection matrix occurs when an accumulation cycle is finished. The overall algorithm is summarized in Algorithm 1:

Algorithm 1 Gradient accumulation with FLORA.

| Require: rank r ∈ [symbol] ₊ | | |
|---|---|---|
| Require: accumulating steps τ ∈ [symbol] ₊ | | |
| Require: gradient function ∇_{W}f(·;·) | | |
| Require: weight matrices [symbol] = {W^{(l)}: dim(W^{(l)}) = 2} | | |
| | [symbol] Initialization of the accumulator state | |
| 1: | for W ∈ [symbol] do | |
| 2: | C_{W} ← 0^{n×r} | O(nr) |
| 3: | s_{W} ← an independent random seed | |
| 4: | end for | |
| | [symbol] Accumulating the compressed gradients | |
| 5: | for i ∈ [τ] do | |
| 6: | for W ∈ [symbol] do | |
| 7: | G_{W} ← ∇_{W}fᵢ( [symbol] ) | G_{W} ∈ [symbol] ^{n×m} |
| 8: | A_{W} ← [symbol] ₛ_{_{W}}(0,1/r) | A_{W} ∈ [symbol] ^{r×m} |
| 9: | C_{W} ← C_{W} + G_{W}A_{W}^{T} | Compression |
| 10: | end for | |
| 11: | end for | |
| | [symbol] Reconstruction | |
| 12: | for W ∈ [symbol] do | |
| 13: | A_{W} ← [symbol] ₛ_{_{W}}(0,1/r) | A_{W} ∈ [symbol] ^{r×m} |
| 14: | \tilde{G}_{W} ← (1/n)D_{W}A_{W} | [symbol] Decompression |

| | |
|---|---|
| 15: | end for |
| 16: | return {\tilde{G}_{W}: W ∈ [symbol] } Overwrite {G_{W}} |

In another example, Flora may be used in respect of the momentum technique. The momentum technique is widely used in modern deep learning to reduce the variance of the gradient and accelerate training [35, 15, 19]. However, it requires maintaining an additional momentum scalar for each parameter, which is expensive when the model is large.

Similar to the compressed gradient accumulation, the momentum can also be compressed with Flora. For each time step t, the new gradient Gₜ is down projected by a random projection matrix Aₜ^{T}. However, the difficulty for accumulating momentum emerges when a Aₜ different from Aₜ₋₁ is used, as the original momentum cannot be reconstructed from Gₜ₋₁Aₜ₋₁^{T}+GₜAₜ^{T}. This difficulty applies to all EMA updates where the number of accumulation steps is not finite. In this case, resampling new matrices will result in a loss of historical accumulation.

Two remedies may be applied to address this issue. First, the same projection matrix is kept for a long time to reduce the distortion. Second, the compressed momentum is transferred from the old projection to a new one by Mₜ=Mₜ₋₁Aₜ₋₁Aₜ^{T}. This is justified by Aₜ₋₁^{T}Aₜ₋₁ and Aₜ^{T}Aₜ are approximately the identity matrix based on Theorem (2).

The final algorithm is shown in Algorithm 2. Overall, for each weight matrix W E [symbol] ^{n×m} the momentum term Mₜ is preserved with sublinear memory. Compared with the original momentum, the memory is reduced from O(nm) to O(nr). It should be pointed out that although momentum is tracked specifically in this case, the algorithm can be easily extended to other EMA-based statistics.

Algorithm 2 Momentum with FLORA.

Require: decay rates 0 ≤ β ≤ 1
Require: rank r ∈ [symbol] ₊, interval κ ∈ [symbol] ₊
Require: gradient function ∇_{W}f(·;·)
Require: weight [symbol] = {W^{(l)}: dim(W^{(l)}) = 2}

| | [symbol] Initialize the optimizer state | |
|---|---|---|
| 1: | t ← 0 | |
| 2: | for W ∈ [symbol] do | |
| 3: | M_{t,W} ← 0^{n×r} | |
| 4: | s_{t,W} ← an independent random seed | |
| 5: | end for | |
| | [symbol] Training procedure | |
| 6: | while training not converged do | |
| 7: | for W ∈ [symbol] do | |
| 8: | G_{t,W} ← ∇_{W}fₜ( [symbol] ) | G_{t,W} ∈ [symbol] ^{n×m} |
| 9: | A_{t,W} ~ [symbol] ₛ_{_{t,W}}(0,1/r) | A_{t,W} ∈ [symbol] ^{r×m} |
| 10: | if t ≡ 0(modκ) then | |
| 11: | s_{t+1,W} ← an independent random seed | |
| 12: | A′_{t+1,W} ~ [symbol] ₛ_{_{t+1,W}}(0,1/r) | A′_{t+1,W} ∈ [symbol] ^{r×m} |
| 13: | M′ ← M_{t,W}A_{t,W}A_{t+1,W}^{T} | |
| 14: | else | |
| 15: | s_{t+1,W} ← s_{t,W} | |
| 16: | A′_{W} ← A_{t,W} | |
| 17: | M′ ← M_{t,W} | |
| 18: | end if | |
| 19: | M_{t+1,W} ← βM′ + (1 − β)G_{t,W}A′_{W}^{T} | |
| 20: | end for | |
| 21: | yield {M_{t+1,W}A′_{W}: W ∈ [symbol] } | [symbol] Decompression |

| | |
|---|---|
| 22: | t ← t + 1 |
| 23: | end while |

It should be pointed out that neither LoRA nor Flora saves the memory for back-propagation. This is because

$$\frac{\partial ℒ}{\partial W}$$

is needed for the update of A and B in LoRA [11], while in Flora the gradient is also compressed and decompressed.

That being said, saving the memory of optimization states alone may be valuable in respect of training large models [10]. Flora compresses both the AM and EMA of gradients to the sublinear level, which shares the same asymptotic rate as LoRA. In implementation, the random seed that generates the projection matrix may be stored—which is highly efficient, as each element can be sampled independently with simple operations—instead of maintaining the same project matrix over batches. This allows the Flora to further save memory in practice with buffer reuse. On the contrary, LoRA needs to maintain two weight matrices A and B, as well as their AM or EMA matrices. As demonstrated empirically below, Flora consumes less memory than LoRA while facilitating high-rank updates and outperforming LoRA to a large extent.

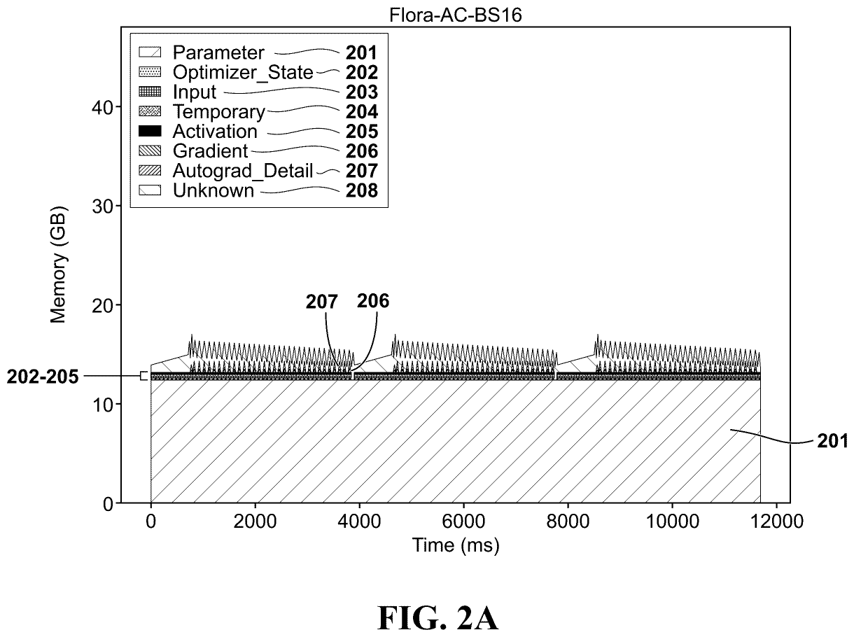

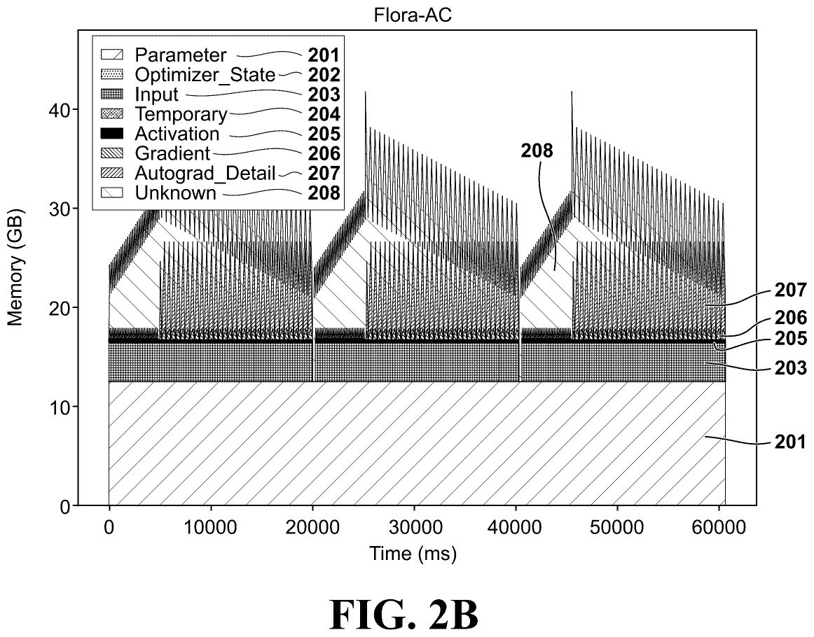

FIGS. 2A and 2B depict memory usage when applying an example embodiment of Flora to train the LLaMa2-7B model using two different batch sizes of training data. Namely, FIG. 2A uses a batch size of 16 and FIG. 2B uses a batch size of 128.

### Experiments

### Experimental Setup

Given the exceptional ability of language models, Transformer-based models were considered for the experiments. Specifically, two representative models were selected, including the T5 [40] and GPT-2 [38] series. For the T5 series, T5-small was used to represent small models and T5-3B to represent large models. T5-small had around 60 M parameters, with a hidden dimension set to 512, while T5-3B had around 3B parameters with a hidden dimension of 1024. For the GPT-2 series, the base version was used to represent small models and GPT-2-XL to represent large models. The base version had around 110 M parameters, with a hidden dimension set to 768, while the large version had around 1.5B parameters with a hidden dimension of 1600.

To facilitate evaluation, two conditional language modeling tasks were used: summarization and translation.

For the summarization task, T5 was trained on the XSum dataset [34]. In these experiments, a pre-trained model was fine tuned in the gradient accumulation experiment, and the model was trained from scratch in the momentum experiment. Each sample was a news article with a summary. The task was to generate a summary of the article. For each input, the prefix “summarize:” was appended to the source sentence in the encoder [40]. The source and target sentences were truncated to 512 and 128 tokens, respectively.

For the translation task, the setting of [25] was followed and GPT-2 was trained on the IWSLT-2017 German-English dataset [4]. Each sample was a German sentence with its English translation. The task was to generate the English translation of the German sentence. For each input, the template “translate German to English: [source]. English: [target]” was used for training [40].

For the summarization task, the widely used ROUGE scores [24], including ROUGE-1, ROUGE-2, and ROUGE-L (R₁/R₂/R_{L}) were used to evaluate the quality of the generated summary. For the translation task, the most commonly used SacreBLEU score [37] was used to evaluate the translation quality. For both ROUGE and SacreBLEU scores, the higher the score, the better the quality of the generated text.

To get more insights into the training process, peak memory usage was monitored with the built-in JAX profiling tool [2]. The excessive memory Δ_{M} compared with the method where accumulation or momentum was disabled is also shown below. The memory is reported in GiB (1024³ bytes).

In this experiment, Adafactor was used as the base optimizer, which is the default optimizer for many Transformer models including T5 [40], and is reported to be empirically better than Adam [39]. The official Adafactor implementation in Optax was used [9].

The following methods were compared: (1) None: a baseline that does not use gradient accumulation or momentum; (2) Naive: a naive implementation of gradient accumulation or momentum, which stores the full information along training; (3) LoRA: the original LoRA method where only the LoRA patches are trained; (4) Flora: an example embodiment of the present disclosure that compresses the gradients and decompresses them when updating the original weights. For LoRA and Flora, projections were applied to attention and feed-forward layers only, while following the naive procedure for other layers (i.e., token embeddings and vector weights).

For small models (T5-small and GPT-2 base), the rank r was tested from 8 to 256, ranging from the very low dimension to half of the hidden dimension, for a thorough examination of different methods. For large models (T5-3B and GPT-2-XL), r was tested from 16 to 512 to approximately maintain the same percentage of memory saving as small models. Neither learning rate schedules [28] nor weight decay [29] was applied in any experiments to rule out the influence of these techniques.

### Main Results

In respect of gradient accumulation, pre-trained models with 16 gradient accumulation steps were fine tuned. To achieve a minimal memory footprint and fit large models, the physical batch size was set to 1. The learning rate was swept from 10⁻⁵ to 10⁻¹ with the naive accumulation method on the validation loss. The best learning rate was applied to other methods excluding LoRA, which was tuned individually as it was reported to have different optimal learning rates [18]. For each run, the model was fine tuned for 1 epoch to prevent over-fitting following the common practice [46]. The results are reported on the test set based on the checkpoint with the lowest validation loss.

The results are presented in Table 1. In Table 1, the size indicates the total number of the original model parameters, and the numbers in brackets denote the rank r of the random projection matrix. As shown, the naive gradient accumulation improved the ROUGE scores over the method without accumulation, but it lead to a large memory usage, which was similar to the model size, to store the accumulation. For LoRA, it was empirically observed that LoRA generally did not reduce memory usage in this case as the state of Adafactor is already sublinear. In fact, it increased memory because it stored another four low-rank matrices for each weight matrix and added an additional Jacobian path for the automatic differentiation.

In contrast, Flora reduced the memory footprint on all benchmarks compared with the naive accumulation. In addition, when r was reasonably large, Flora was able to recover the performance (in ROUGE or BLEU scores) of full-matrix accumulation and surpass the baseline that accumulation was not enabled. Notably, for the large models (T5-3B and GPT-2-XL), the memory overhead of Flora (r=256) was only 30% of the naive accumulation, while the performance was on par.

TABLE 1
Results of Different Methods to Compress Gradient Accumulation
(a) The results of T5 variants on XSum.

| Size | Accumulation | Mem | Δ_{M} | R ₁/R ₂/R _{L} |
|---|---|---|---|---|
| 60 M | None | 0.75 | — | 33.4/11.4/26.4 |
| | Naive | 0.87 | 0.12 | 34.0/11.5/26.7 |
| | LoRA (8) | 0.82 | 0.07 | 30.4/8.60/23.6 |
| | LoRA (32) | 0.86 | 0.11 | 30.7/8.90/23.9 |
| | LoRA (128) | 0.94 | 0.19 | 31.0/9.10/24.1 |
| | LoRA (256) | 1.07 | 0.32 | 31.4/9.34/24.5 |
| | F_{LORA} (8) | 0.75 | 0.00 | 31.5/9.67/24.6 |
| | F_{LORA} (32) | 0.75 | 0.00 | 32.2/10.3/25.2 |
| | F_{LORA} (128) | 0.77 | 0.02 | 33.2/10.9/26.0 |
| | F_{LORA} (256) | 0.79 | 0.04 | 33.6/11.3/26.5 |
| | None | 16.7 | — | 42.5/19.1/34.6 |
| | Naive | 26.6 | 9.9 | 44.4/20.9/36.3 |
| | LoRA (16) | 27.8 | 11.1 | 42.2/18.4/34.0 |
| | LoRA (64) | 29.5 | 12.8 | 42.3/18.6/34.1 |
| 3 B | LoRA (256) | 33.4 | 16.7 | 42.6/18.9/34.4 |
| | LoRA (512) | OOM | — | — |
| | F_{LORA} (16) | 17.0 | 0.3 | 43.5/20.0/35.5 |
| | F_{LORA} (64) | 18.2 | 1.5 | 43.9/20.3/35.8 |
| | F_{LORA} (256) | 19.5 | 2.8 | 44.3/20.7/36.2 |
| | F_{LORA} (512) | 22.1 | 5.4 | 44.5/20.9/36.4 |

(b) The results of GPT-2 variants on IWSLT17 De-En.

| Size | Accumulation | Mem | Δ_{M} | BLEU |
|---|---|---|---|---|
| | None | 2.77 | — | 17.9 |
| | Naive | 3.24 | 0.47 | 24.9 |
| | LoRA (8) | 3.25 | 0.48 | 9.94 |
| | LoRA (32) | 3.29 | 0.52 | 11.2 |
| 110 M | LoRA (128) | 3.38 | 0.60 | 12.2 |
| | LoRA (256) | 3.52 | 0.75 | 13.4 |
| | F_{LORA} (8) | 2.93 | 0.15 | 16.3 |
| | F_{LORA} (32) | 2.94 | 0.16 | 22.0 |
| | F_{LORA} (128) | 2.98 | 0.20 | 24.0 |
| | F_{LORA} (256) | 3.03 | 0.26 | 25.4 |
| | None | 20.8 | — | 28.2 |
| | Naive | 26.5 | 5.78 | 33.2 |
| | LoRA (16) | 26.8 | 6.02 | 17.4 |
| | LoRA (64) | 27.4 | 6.68 | 19.5 |
| 1.5 B | LoRA (256) | 28.9 | 8.15 | 20.7 |
| | LoRA (512) | OOM | — | — |
| | F_{LORA} (16) | 21.1 | 0.34 | 29.7 |
| | F_{LORA} (64) | 21.3 | 0.52 | 31.6 |
| | F_{LORA} (256) | 21.9 | 1.17 | 33.2 |
| | F_{LORA} (512) | 22.8 | 2.04 | 33.6 |

Given that the momentum technique is ineffective in fine-tuning [26], all models were trained from scratch in respect of the momentum technique. The physical batch size was set to 4 as a result of balancing the generalization and variance reduction [31]. The gradient accumulation technique was disabled to rule out its impact. Due to the expense of training from scratch, only the small variants of each series were tested. Similar to the settings in gradient accumulation, the learning rate was swept for the naive momentum method from 10⁻⁵ to 10⁻¹ on the validation loss. The best learning rates were applied to all methods excluding LoRA, which again had its own optimal learning rate. The hyper-parameter K (resampling interval) was set to 1000 for all runs of Flora. The effect of different values of K is discussed below.

As shown in Table 2, the naive momentum technique achieved better performance than no compression at a cost of more memory usage. In Table 2, the size indicates the total number of the original model parameters and the numbers in brackets denote the rank r of the random projection matrix. Similar to the results in gradient accumulation, LoRA did not save memory given the optimization state was already sublinear. It also had a significantly lower performance when trained from scratch, as the overall matrix update can only be low-rank.

TABLE 2
Results of Compressing Momentum

| Setting | Momentum | Mem | R ₁/R ₂/R _{L} |
|---|---|---|---|
| | None | 1.65 | 29.4/9.11/23.3 |
| | Naive | 1.89 | 29.9/9.40/23.8 |
| | LoRA (8) | 1.88 | 18.0/3.33/14.9 |
| | LoRA (32) | 1.91 | 20.4/4.20/16.7 |
| T5 60 M | LoRA (128) | 2.05 | 21.5/4.82/17.4 |
| XSum | LoRA (256) | 2.13 | 22.2/5.04/17.9 |
| | F_{LORA} (8) | 1.71 | 25.5/6.56/20.4 |
| | F_{LORA} (32) | 1.72 | 26.9/7.32/21.5 |
| | F_{LORA} (128) | 1.75 | 29.1/8.76/23.2 |
| | F_{LORA} (256) | 1.79 | 30.2/9.51/24.0 |
| Setting | Momentum | Mem | BLEU |
| | None | 8.95 | 19.4 |
| | Naive | 9.45 | 19.9 |
| | LoRA (8) | 9.42 | 4.98 |
| | LoRA (32) | 9.46 | 6.76 |
| GPT-2 110 M | LoRA (128) | 9.55 | 8.72 |
| IWSLT17 | LoRA (256) | 9.76 | 9.83 |
| | F_{LORA} (8) | 9.09 | 9.14 |
| | F_{LORA} (32) | 9.10 | 14.9 |
| | F_{LORA} (128) | 9.14 | 18.6 |
| | F_{LORA} (256) | 9.20 | 19.9 |

Flora utilized less memory than the naive momentum. In addition, Flora recovered (or even surpassed) the performance of naive momentum when r was increased. This significantly distinguishes Flora from LoRA as it achieved memory-efficient training even when the initialization was random.

### In-Depth Analyses

In the above momentum implementation, a hyper-parameter K controlled the resampling frequency of the random-projection matrix. Below, the effect of K is analyzed with T5-small on the summarization task as the testbed, due to the limit of time and resources. K is varied by keeping other hyper-parameters the same as above.

The results are shown in Table 3. It is seen that, when K is below 1000, the ROUGE scores increase with κ. After a certain threshold, however, performance starts to decrease. This aligns with the interpretation that the information is better preserved within the interval, but each interval is bottlenecked by the rank. Given the results, κ=1000 was used above to balance the preserved information and the overall rank of momentum.

TABLE 3

| Effect of κ in Momentum | | | |
|---|---|---|---|
| Setting | κ | Mem | R ₁/R ₂/R _{L} |
| T5 60 M | 1 | 1.79 | 0.00/0.00/0.00 |
| XSum | 10 | 1.79 | 27.5/7.68/31.8 |
| | 100 | 1.79 | 29.3/8.89/23.2 |
| | 1000 | 1.79 | 30.4/9.70/24.2 |
| | 10000 | 1.79 | 29.5/9.11/23.5 |

In the above main experiments, a counter-intuitive phenomenon was observed in that LoRA empirically increased memory usage. This is likely because the optimization states in Adafactor were already sublinear, rendering the ineffectiveness of LoRA to save memory in this case. To further verify Flora in linear-memory optimizers, the performance with a variant of Adafactor where the second-moment estimates were not factorized was tested, essentially making it a linear-memory optimizer. All the other hyper-parameters remain the same as above.

Table 4 shows the results. As seen, LoRA indeed saved more memory than Flora when the rank was low (r<128) in linear-memory optimizers. However, Flora became more memory-efficient for r=256, because it has a lower constant in the complexity. Moreover, Flora largely outperformed LoRA in all settings by 2-3 ROUGE points, showing Flora's superiority.

TABLE 4
Results of linear memory optimizers

| Setting | Momentum | Mem | R ₁/R ₂/R _{L} |
|---|---|---|---|
| | None | 0.99 | 33.0/11.1/26.1 |
| | Naive | 1.12 | 34.0/11.5/26.7 |
| | LoRA (8) | 0.82 | 28.7/7.51/22.0 |
| | LoRA (32) | 0.86 | 29.0/7.71/22.3 |
| T5 60 M | LoRA (128) | 1.00 | 29.7/8.02/22.9 |
| XSum | LoRA (256) | 1.20 | 30.0/8.28/23.2 |
| | F_{LORA} (8) | 1.00 | 31.6/9.72/24.7 |
| | F_{LORA} (32) | 1.00 | 32.3/10.3/25.3 |
| | F_{LORA} (128) | 1.00 | 33.2/10.9/26.0 |
| | F_{LORA} (256) | 1.04 | 33.5/11.1/26.3 |

### Comparison to Alternative Methods

Many methods have been proposed to improve the parameter efficiency of fine-tuning large models. A straightforward way is to tune a subset of the model, such as the top layers [27] and bias vectors [48]. Another way is to add small tunable modules (e.g., Adapter and LoRA) to the pre-trained model. Although reducing the optimization memory, these methods suffer from the problem that the model parameters are restricted. For example, the total weight change of LoRA is constrained to be low-rank. In an attempt to achieve high-rank updates, ReLoRA [22]proposes to periodically reinitialize the LoRA patch. However, it requires full-weight pre-training to work properly, growing the peak memory linearly in model size. By contrast, Flora is able to directly start from scratch and achieve full-training performance, while maintaining a sublinear complexity throughout the process.

Principal component analysis [43] or matrix sketching [23] use singular value decomposition (SVD) to approximate the large matrix with smaller matrices. However, the SVD procedure is computationally expensive and difficult to be parallelized, making it impractical for large-scale training. Another way to compress the matrix is to use random projection [1]; Flora additionally involves a simple and efficient decompression procedure justified by Theorem (2). The simplification saves both computation and memory usage.

Optimization states contribute significantly to memory usage for large-scale training [10]. Memory-efficient optimizers [42, 13] are shown to effectively reduce the memory footprint. Flora is orthogonal to these methods, as it can be applied to enhance existing optimizers by compressing the momentum or gradient accumulation.

It is also possible to reduce the memory footprint of back-propagation with advanced techniques like gradient checkpointing [5], mixed-precision training [33], randomized auto differentiation [36], or zeroth-order optimization [30]. Flora can be combined with these methods to further save memory.

In the above examples, the largest model has 3B parameters. For extremely large models like GPT-3, one estimate is that the compressed optimization state of r=256 would only be 2.08% of its original memory, which would be of great practical significance. Additionally, while Flora is described above as being applicable to large language models, it is not limited to language models. Rather, it is generally applicable to transformers and to neural networks more generally.

Combination with Low Memory Optimizer

One option during optimization is to fuse gradient optimization and the parameter update steps of neural network training together in order to reduce memory usage; this is referred to as “Low-Memory Optimization”, or “LOMO” [49]. In LOMO, gradient determination and parameter optimization are done on a per layer basis, as opposed to a conventional implementation of an optimizer such as Adam in which gradients are determined on a per layer basis and parameter optimization is done concurrently for all layers once their respective gradients have been determined. In at least some embodiments, LOMO may be combined with Flora so as to receive a synergistic combination of the memory efficiency benefits of Flora discussed above, as well as those that result from LOMO. More particularly, LOMO allows the temporary tensors created by Flora to appear at different points of time, rather than concurrently, reducing peak memory usage, thereby resulting in a combined benefit greater than what would be expected from simply summing the benefits of Flora and LOMO together.

The following pseudocode provides an example of combining Algorithms 1 and 2 above, which are examples of Flora, together with LOMO when using Adafactor as an optimizer:

| | |
|---|---|
| 1 | while training: |
| 2 | for gradient accumulation steps: |
| 3 | do forward pass on a small mini-batch |
| 4 | for layer in reversed (model): |
| 5 | grad = grad_fcn(layer); |
| 6 | state[layer] = state[layer] + |
| 7 | flora_compress(grad) / accumulation_steps; |
| 8 | del grad; |
| 9 | if accumulation_finished: |
| 10 | grad = flora_decompress(state[layer]); |
| 11 | del state[layer]; |
| 12 | optimizer.update(layer, grad); |

The while loop starting at line 1 of the pseudocode is an outer training iteration loop. As shown in line 2, this pseudocode implements the gradient accumulation method of Algorithm 1. A forward pass on a small mini-batch of training data is done at line 3; this generates an output from the neural network being trained, which subsequently allows a loss and gradient to be determined. Per layer gradient accumulation and consequent optimizer updates begin on line 4; the last layer is updated first, and layers are updated sequentially from last to first. The for loop starting on line 4 of the pseudocode corresponds to line 5 of Algorithm 1. The gradient for a particular layer is determined at line 5, which is analogous to line 7 of Algorithm 1. A compressed optimization state for that layer is then determined at lines 6 and 7, determined from the arithmetic mean of the compressed gradient determined using Flora over the number of steps for which the gradient was accumulated; this corresponds to line 9 of Algorithm 1. Once the accumulation of gradients is determined to have finished at line 9, the averaged gradient is decompressed at line 10; this corresponds to line 14 of Algorithm 1. At line 12, the optimizer (Adafactor) updates the weights for that particular layer based on the decompressed gradient. During performance of line 12, a per layer version of Algorithm 2 is performed (i.e., without the loop over all layers represented by lines 7-19 of Algorithm 2, and by performing a single layer decompression variant of line 21 of Algorithm 2).

In the above pseudocode, the fact that gradient accumulation and the update performed by the optimizer are executed in a per layer fashion represents LOMO. In at least some other embodiments, Flora may be combined with LOMO without being limited to gradient accumulation (or a momentum calculation), such as by being used to compress and then decompress a different parameter or metric used by an optimizer, or a variant of gradient accumulation or momentum described above. For example, in at least some alternative embodiments, Flora may be used to compress and decompress Nesterov momentum, or more generally other operations or optimizer states based on gradients, so long as those gradient-related operations are linear.

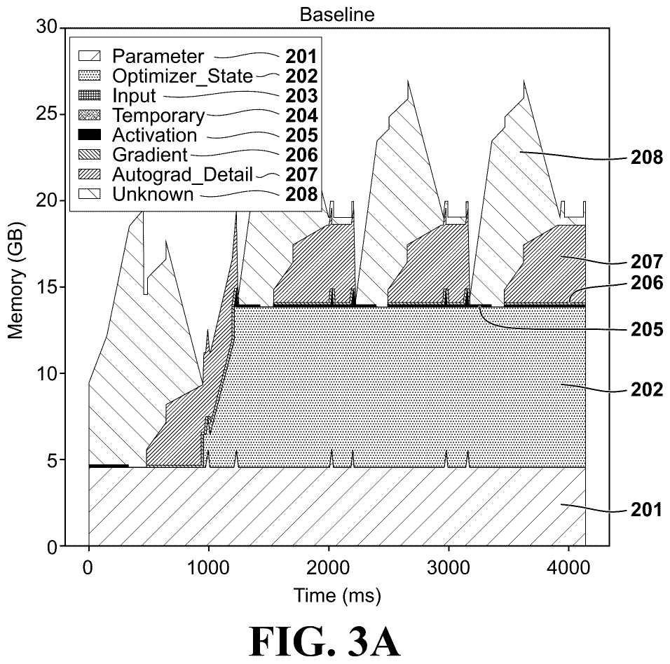

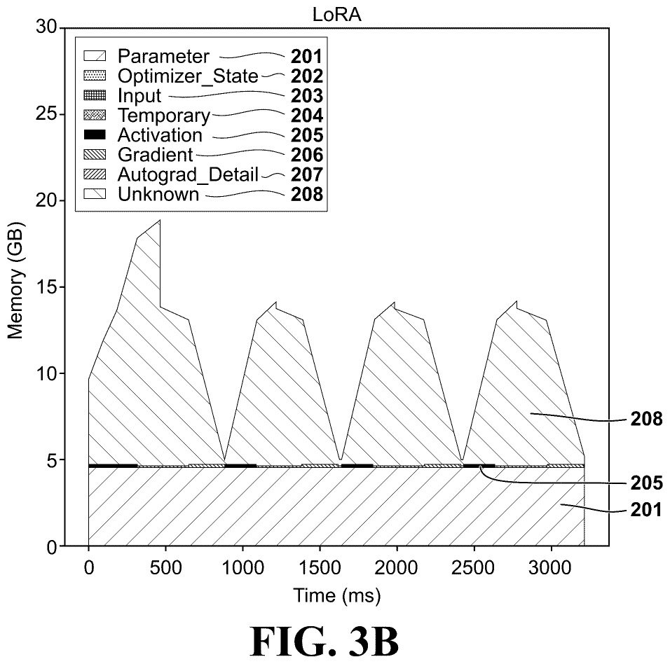

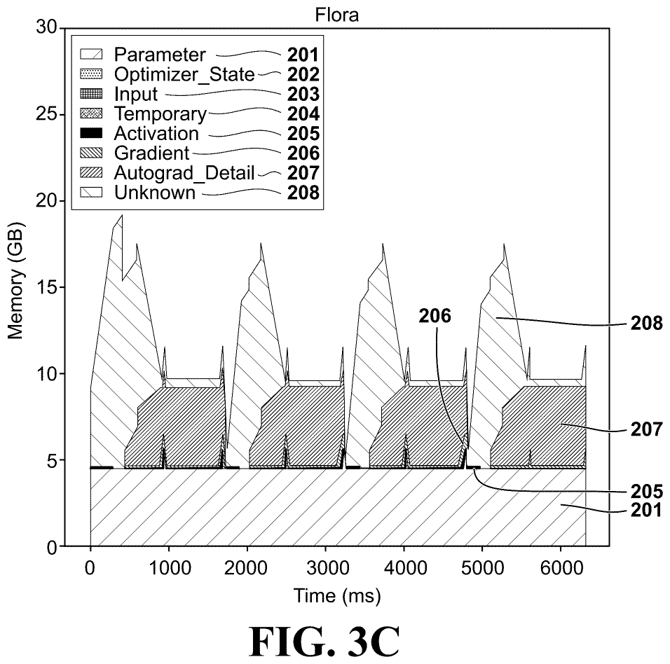

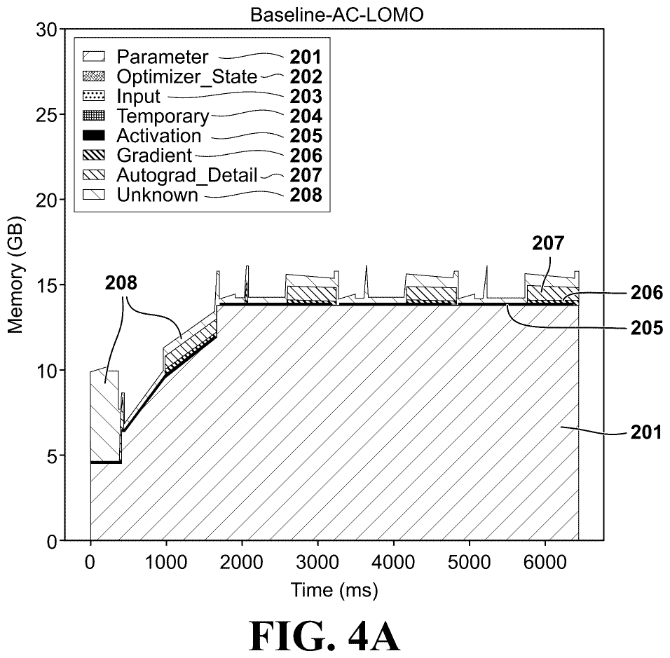

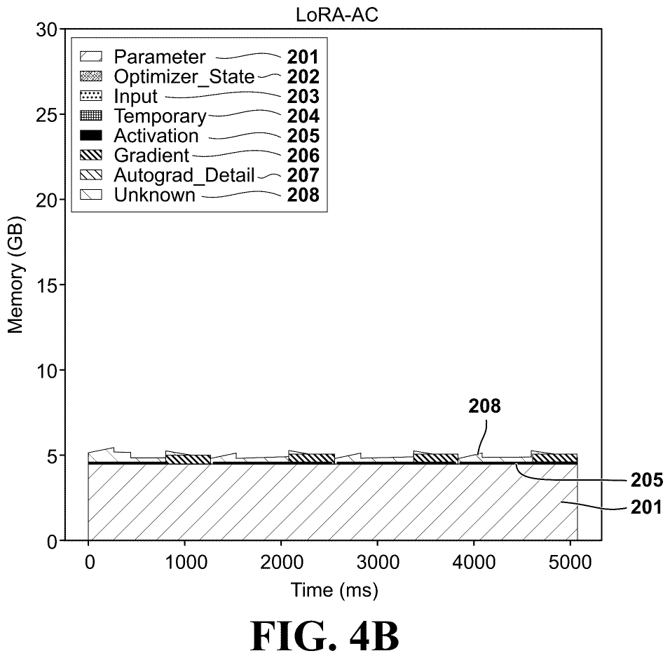

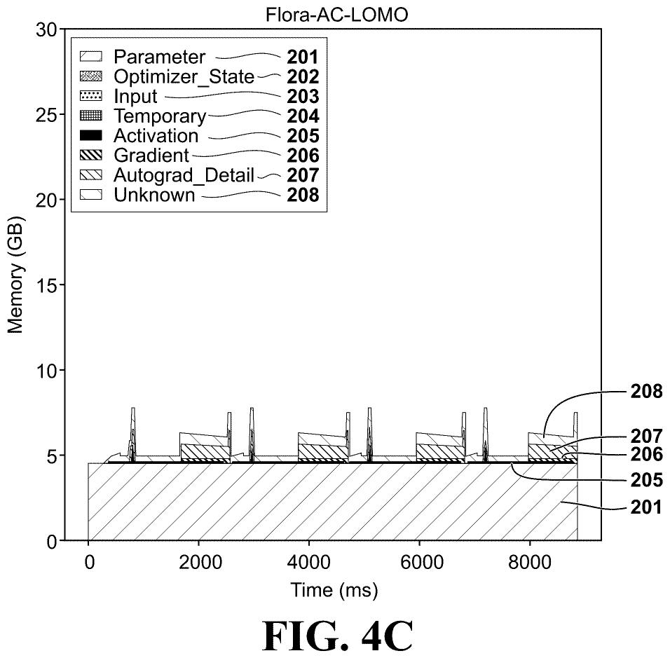

The memory efficiency of Flora, and Flora combined with LOMO, is shown in FIGS. 3A-3C and 4A-4C. FIGS. 3A-3C depict memory usage during neural network training in a baseline case (i.e., one that does not use gradient accumulation or momentum) (FIG. 3A), the original LoRA method where only the LoRA patches are trained (FIG. 3B), and an example embodiment of Flora (FIG. 3C), none of which is also applying LOMO. FIGS. 4A-4C correspond to FIGS. 3A-3C, except LOMO is also applied to the baseline, LoRA, and Flora cases, respectively. The memory savings during training when LOMO is applied is evident from the graphs. In these figures, reference numerals 201-208 represent the amount of memory allocated for parameters (201); optimizer state (202); input (203); temporarily (204); activation (205); gradient (207); Autograd (207); and unknown (208).

In the foregoing, Flora enables sublinear memory in a number of parameters by reducing memory needed for optimizer states. This complements the Adafactor optimizer in particular. Adafactor has been competitive with other optimizers such as Adam. However, unlike Adam, Adafactor doesn't consider momentum, which puts it at disadvantage in many types of problems. Naively augmenting Adafactor with momentum breaks Adafactor's sublinear memory property. However, combining Adafactor with Flora yields an optimizer that is overall sublinear and has both momentum and root-mean-square normalization (also known as an adaptive learning rate). The momentum experiments in the particular embodiments above describe the benefits of a sublinear-momentum-augmented Adafactor optimizer, and are generally extensible to analogous optimizers.

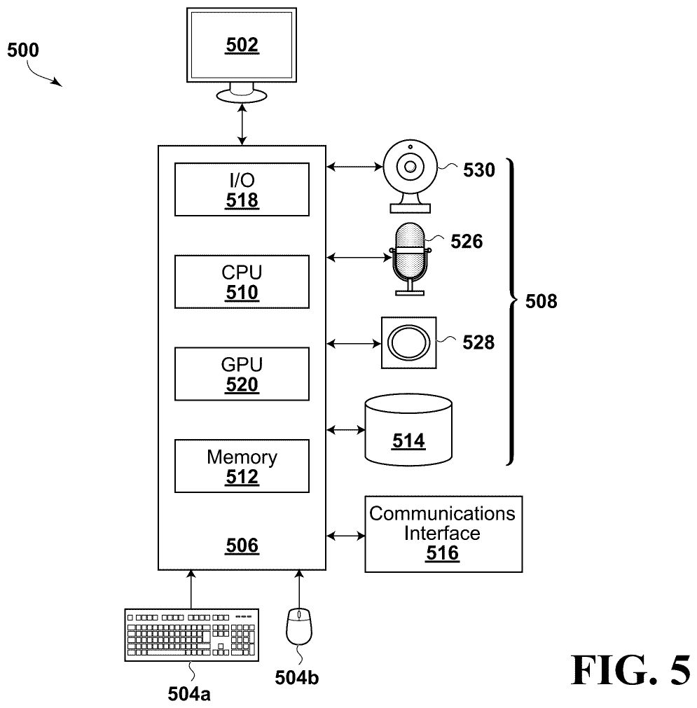

An example computer system in respect of which a method for memory efficient neural network training described above may be implemented is presented as a block diagram in FIG. 5. The example computer system is denoted generally by reference numeral 500 and includes a display 502, input devices in the form of keyboard 504a and pointing device 504b, computer 506 and external devices 508. While pointing device 504b is depicted as a mouse, it will be appreciated that other types of pointing device, or a touch screen, may also be used.

The computer 506 may contain one or more processors or microprocessors, such as a central processing unit (CPU) 510. The CPU 510 performs arithmetic calculations and control functions to execute software stored in a non-transitory internal memory 512, preferably random access memory (RAM) and/or read only memory (ROM), and possibly additional memory 514. The additional memory 514 is non-transitory may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 514 may be physically internal to the computer 506, or external as shown in FIG. 5, or both.

The one or more processors or microprocessors may comprise any suitable processing unit such as an artificial intelligence accelerator, programmable logic controller, a microcontroller (which comprises both a processing unit and a non-transitory computer readable medium), AI accelerator, system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

Any one or more of the methods described above may be implemented as computer program code and stored in the internal and/or additional memory 514 for execution by the one or more processors or microprocessors to effect neural network pre-training, training, or use of a trained network for inference.

The computer system 500 may also include other similar means for allowing computer programs or other instructions to be loaded. Such means can include, for example, a communications interface 516 which allows software and data to be transferred between the computer system 500 and external systems and networks. Examples of communications interface 516 can include a modem, a network interface such as an Ethernet card, a wireless communication interface, or a serial or parallel communications port. Software and data transferred via communications interface 516 are in the form of signals which can be electronic, acoustic, electromagnetic, optical or other signals capable of being received by communications interface 516. Multiple interfaces, of course, can be provided on a single computer system 500.

Input and output to and from the computer 506 is administered by the input/output (I/O) interface 518. This I/O interface 518 administers control of the display 502, keyboard 504a, external devices 508 and other such components of the computer system 500. The computer 506 also includes a graphical processing unit (GPU) 520. The latter may also be used for computational purposes as an adjunct to, or instead of, the CPU 510, for mathematical calculations.

The external devices 508 include a microphone 526, a speaker 528 and a camera 530. Although shown as external devices, they may alternatively be built in as part of the hardware of the computer system 500.

The various components of the computer system 500 are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a file” or “the file” does not exclude embodiments in which multiple files are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means A, B, C; A and B; A and C; B and C; and A, B, and C.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present. The term “or” is generally employed in its sense including “and/or” unless the content clearly dictates otherwise.

It is contemplated that any part of any aspect or embodiment discussed in this specification can be implemented or combined with any part of any other aspect or embodiment discussed in this specification, so long as such implementation or combination is not performed using mutually exclusive parts.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

### REFERENCES

[1] Ella Bingham and Heikki Mannila. Random projection in dimensionality reduction: applications to image and text data. In KDD, pages 245-250, 2001.
[2] James Bradbury, Roy Frostig, Peter Hawkins, Matthew James Johnson, Chris Leary, Dougal Maclaurin, George Necula, Adam Paszke, Jake VanderPlas, Skye Wanderman-Milne, and Qiao Zhang. JAX: composable transformations of Python+NumPy programs, 2018.
[3] Tom Brown, Benjamin Mann, Nick Ryder, Melanie Subbiah, Jared D Kaplan, Prafulla Dhariwal, Arvind Neelakantan, Pranav Shyam, Girish Sastry, Amanda Askell, Sandhini Agarwal, Ariel Herbert-Voss, Gretchen Krueger, Tom Henighan, Rewon Child, Aditya Ramesh, Daniel Ziegler, Jeffrey Wu, Clemens Winter, Chris Hesse, Mark Chen, Eric Sigler, Mateusz Litwin, Scott Gray, Benjamin Chess, Jack Clark, Christopher Berner, Sam McCandlish, Alec Radford, Ilya Sutskever, and Dario Amodei. Language models are few-shot learners. In NeurIPS, pages 1877-1901, 2020.
[4] Mauro Cettolo, Marcello Federico, Luisa Bentivogli, Jan Niehues, Sebastian Stiiker, Katsuhito Sudoh, Koichiro Yoshino, and Christian Federmann. Overview of the IWSLT 2017 evaluation campaign. In IWSLT, pages 2-14, 2017.
[5] Tianqi Chen, Bing Xu, Chiyuan Zhang, and Carlos Guestrin. Training deep nets with sublinear memory cost. arXiv preprint arXiv:1604.06174, 2016.
[6] Ashok Cutkosky and Francesco Orabona. Momentum-based variance reduction in non-convex SGD. In NeurIPS, 2019.
[7] Sanjoy Dasgupta and Anupam Gupta. An elementary proof of a theorem of johnson and lindenstrauss. Random Structures & Algorithms, 22(1):60-65, 2003.
[8] Sanjoy Dasgupta. Experiments with random projection. In UAI, pages 143-151, 2000.
[9] DeepMind, Igor Babuschkin, Kate Baumli, Alison Bell, Surya Bhupatiraju, Jake Bruce, Peter Buchlovsky, David Budden, Trevor Cai, Aidan Clark, Ivo Danihelka, Antoine Dedieu, Claudio Fantacci, Jonathan Godwin, Chris Jones, Ross Hemsley, Tom Hennigan, Matteo Hessel, Shaobo Hou, Steven Kapturowski, Thomas Keck, Iurii Kemaev, Michael King, Markus Kunesch, Lena Martens, Hamza Merzic, Vladimir Mikulik, Tamara Norman, George Papamakarios, John Quan, Roman Ring, Francisco Ruiz, Alvaro Sanchez, Laurent Sartran, Rosalia Schneider, Eren Sezener, Stephen Spencer, Srivatsan Srinivasan, Miloš Stanojević, Wojciech Stokowiec, Luyu Wang, Guangyao Zhou, and Fabio Viola. The DeepMind JAX Ecosystem, 2020.
[10] Tim Dettmers, M. Lewis, Sam Shleifer, and Luke Zettlemoyer. 8-bit optimizers via block-wise quantization. In ICLR, 2021.
[11] Tim Dettmers, Artidoro Pagnoni, Ari Holtzman, and Luke Zettlemoyer. QLoRA: Efficient finetuning of quantized LLMs. In NeurIPS, 2023.
[12] John Duchi, Elad Hazan, and Yoram Singer. Adaptive subgradient methods for online learning and stochastic optimization. JMLR, 12(7), 2011.
[13] Vladimir Feinberg, Xinyi Chen, Y. Jennifer Sun, Rohan Anil, and Elad Hazan. Sketchy: Memory-efficient adaptive regularization with frequent directions. In NeurIPS, 2023.
[14] Lorenzo Finesso and Peter Spreij. Nonnegative matrix factorization and I-divergence alternating minimization. Linear Algebra and its Applications, 416(2-3):270-287, 2006.
[15] Gabriel Goh. Why momentum really works. Distill, 2017.
[16] Geoffrey Hinton, Nitish Srivastava, and Kevin Swersky. Neural networks for machine learning lecture 6a overview of mini-batch gradient descent. Coursera, 2012.
[17]N. Houlsby, A. Giurgiu, Stanislaw Jastrzebski, Bruna Morrone, Quentin de Laroussilhe, Andrea Gesmundo, Mona Attariyan, and S. Gelly. Parameter-efficient transfer learning for NLP. In ICML, pages 2790-2799, 2019.
[18] Edward J Hu, yelong shen, Phillip Wallis, Zeyuan Allen-Zhu, Yuanzhi Li, Shean Wang, Lu Wang, and Weizhu Chen. LoRA: Low-rank adaptation of large language models. In ICLR, 2022.
[19] Samy Jelassi and Yuanzhi Li. Towards understanding how momentum improves generalization in deep learning. In ICML, pages 9965-10040, 2022.
[20] Diederik P. Kingma and Jimmy Ba. Adam: A method for stochastic optimization. In Yoshua Bengio and Yann LeCun, editors, ICLR, 2015.
[21] Beatrice Laurent and Pascal Massart. Adaptive estimation of a quadratic functional by model selection. Annals of statistics, 28(5):1302-1338, 2000.
[22] Vladislav Lialin, Namrata Shivagunde, Sherin Muckatira, and Anna Rumshisky. Stack more layers differently: High-rank training through low-rank updates. arXiv preprint arXiv: 2307.05695, 2023.
[23] Edo Liberty. Simple and deterministic matrix sketching. In KDD, pages 581-588, 2013.
[24] Chin-Yew Lin. ROUGE: A package for automatic evaluation of summaries. In Text Summarization Branches Out, pages 74-81, 2004.
[25] Zhaojiang Lin, Andrea Madotto, and Pascale Fung. Exploring versatile generative language model via parameter-efficient transfer learning. In EMNLP Findings, pages 441-459, 2020.
[26] Hao Li, Pratik Chaudhari, Hao Yang, Michael Lam, Avinash Ravichandran, Rahul Bhotika, and Stefano Soatto. Rethinking the hyperparameters for fine-tuning. In ICLR, 2020.
[27] Xiang Lisa Li and Percy Liang. Prefix-tuning: Optimizing continuous prompts for generation. In ACL-IJCNLP, volume 1, pages 4582-4597, 2021.
[28] Ilya Loshchilov and Frank Hutter. SGDR: Stochastic gradient descent with warm restarts. In ICLR, 2017.
[29] Ilya Loshchilov and Frank Hutter. Decoupled weight decay regularization. In ICLR, 2019.
[30] Sadhika Malladi, Tianyu Gao, Eshaan Nichani, Alex Damian, Jason D. Lee, Danqi Chen, and Sanjeev Arora. Fine-tuning language models with just forward passes. In NeurIPS, 2023.
[31] Dominic Masters and Carlo Luschi. Revisiting small batch training for deep neural networks. arXiv preprint arXiv:1804.07612, 2018.
[32] Jiři Matoušek. On variants of the johnson-lindenstrauss lemma. Random Structures & Algorithms, 33(2):142-156, 2008.
[33] Paulius Micikevicius, Sharan Narang, Jonah Alben, Gregory Diamos, Erich Elsen, David Garcia, Boris Ginsburg, Michael Houston, Oleksii Kuchaiev, Ganesh Venkatesh, and Hao Wu. Mixed precision training. In ICLR, 2018.
[34] Shashi Narayan, Shay B Cohen, and Mirella Lapata. Donâ€™t give me the details, just the summary!topic-aware convolutional neural networks for extreme summarization. In EMNLP, pages 1797-1807, 2018.
[35] Yurii Nesterov. Introductory Lectures on Convex Optimization: A Basic Course. Springer, 1998.
[36] Deniz Oktay, Nick McGreivy, Joshua Aduol, Alex Beatson, and Ryan P Adams. Randomized automatic differentiation. In ICLR, 2020.
[37] Matt Post. A call for clarity in reporting BLEU scores. In WMT, pages 186-191, 2018.
[38] Alec Radford, Jeffrey Wu, Rewon Child, David Luan, Dario Amodei, Ilya Sutskever, et al. Language models are unsupervised multitask learners. OpenAI blog, 2019.
[39] Jack W Rae, Sebastian Borgeaud, Trevor Cai, Katie Millican, Jordan Hoffmann, Francis Song, John Aslanides, Sarah Henderson, Roman Ring, Susannah Young, et al. Scaling language models: Methods, analysis & insights from training gopher. arXiv preprint arXiv:2112.11446, 2021.
[40] Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. JMLR, 21(1):5485-5551, 2020.
[41] Robin Rombach, Andreas Blattmann, Dominik Lorenz, Patrick Esser, and Bjorn Ommer. High-resolution image synthesis with latent diffusion models. In CVPR, pages 10684-10695, 2022.
[42] Noam Shazeer and Mitchell Stern. Adafactor: Adaptive learning rates with sublinear memory cost. In ICML, pages 4596-4604, 2018.
[43] Jonathon Shlens. A tutorial on principal component analysis. arXiv preprint arXiv: 1404.1100, 2014.
[44] Samuel L Smith, Pieter-Jan Kindermans, Chris Ying, and Quoc V Le. Don't decay the learning rate, increase the batch size. In ICLR, 2018.
[45] Chong Wang, Xi Chen, Alexander J Smola, and Eric P Xing. Variance reduction for stochastic gradient optimization. In NIPS, 2013.
[46] Jeff Wu, Long Ouyang, Daniel M Ziegler, Nisan Stiennon, Ryan Lowe, Jan Leike, and Paul Christiano. Recursively summarizing books with human feedback. arXiv preprint arXiv:2109.10862, 2021.
[47] Han Xiao, Kashif Rasul, and Roland Vollgraf. Fashion-mnist: a novel image dataset for benchmarking machine learning algorithms. arXiv preprint arXiv:1708.07747, 2017.
[48] Elad Ben Zaken, Yoav Goldberg, and Shauli Ravfogel. BitFit: Simple parameter-efficient fine-tuning for transformer-based masked language-models. In ACL, volume 2, pages 1-9, 2022.
[49] Kai Lv, Yuging Yang, Tengxiao Liu, Qinghui Gao, Qipeng Guo, and Xipeng Qiu. Full Parameter Fine-tuning for Large Language Models with Limited Resources. arXiv preprint arXiv:2306.09782, 2023.

1. A memory efficient neural network training method, the method comprising:
(a) performing a forward pass by inputting a batch of training data to a neural network;
(b) determining a loss from an output of the neural network resulting from the forward pass; and
(c) performing back propagation on the neural network, wherein performing the back propagation comprises:
(i) for each layer of the neural network:
(A) determining a gradient and/or optimizer state for the layer of the neural network; and
(B) compressing the gradient and/or optimizer state by performing a random down-projection on the gradient;
(ii) following determining and down projecting the gradients and/or optimizer states for the layers of the neural network, decompressing the gradients and/or optimizer states based on the gradients; and
(iii) updating weights of the neural network based on the decompressed gradients and/or optimizer states, wherein a different random down-projection is used for each layer during the back propagation.

2. The method of claim 1, wherein the updating of the weights is performed on a per layer basis.

3. The method of claim 1, wherein the gradient is determined for each layer.

4. The method of claim 1, wherein the optimizer state is determined for each layer.

5. The method of claim 4, wherein the optimizer state is momentum.

6. The method of claim 1, wherein the random down-projection is performed using a fixed random projection matrix, and wherein the fixed random projection matrix is resampled during the training.

7. The method of claim 6, wherein the fixed random projection matrix is resampled each time the compressing is performed.

8. The method of claim 1, wherein the gradient or optimizer state is averaged over the layers, and wherein the average of the gradient or optimizer state is used to update the weights.

9. The method of claim 8, wherein the average is an arithmetic mean.

10. The method of claim 9, wherein the gradient is an accumulated gradient comprising the gradient for multiple layers, wherein the decompressing comprises determining a mean of the accumulated gradient, and wherein the mean of the accumulated gradient is used to update the weights.

11. The method of claim 8, wherein the average is an exponential moving average.

12. The method of claim 11, wherein the optimizer state is momentum that is averaged over multiple layers, wherein the decompressing comprises decompressing the exponential moving average of the momentum, and wherein the averaged momentum is used to update the weights.

13. The method of claim 12, wherein the random down-projection is performed using a fixed random projection matrix, and wherein the fixed random projection matrix is resampled during the training at a rate lower than for each layer.

14. The method of claim 13, wherein the training is performed over a series of time steps, and wherein the compressed exponential moving average of the momentum for a given one of the time steps is determined from the compressed exponential moving average of the momentum for a prior one of the time steps multiplied by the random projection matrix and a transpose of the random projection matrix.

15. The method of claim 1, wherein the random down-projection is performed using a fixed random projection matrix, and wherein a random seed that generates the fixed random projection matrix is stored across batches in lieu of the fixed random projection matrix.

16. A system for memory efficient neural network training, the system comprising:
(a) at least one database having stored thereon at least one batch of training data;
(b) at least one processing unit communicatively coupled to the at least one database and configured to perform a memory efficient neural network training method, the method comprising:
(i) performing a forward pass by inputting a batch of training data to a neural network;
(ii) determining a loss from an output of the neural network resulting from the forward pass; and
(iii) performing back propagation on the neural network, wherein performing the back propagation comprises:
(A) for each layer of the neural network:
(1) determining a gradient and/or optimizer state for the layer of the neural network; and
(2) compressing the gradient and/or optimizer state by performing a random down-projection on the gradient;
(B) following determining and down projecting the gradients and/or optimizer states for the layers of the neural network, decompressing the gradients and/or optimizer states based on the gradients; and
(C) updating weights of the neural network based on the decompressed gradients and/or optimizer states, wherein a different random down-projection is used for each layer during the back propagation.

17. The system of claim 16, wherein the updating of the weights is performed on a per layer basis.

18. The system of claim 16, wherein the random down-projection is performed using a fixed random projection matrix, and wherein the fixed random projection matrix is resampled during the training.

19. At least one non-transitory computer readable medium having encoded thereon computer program code that is executable by at least one processor and that, when executed by the at least one processor, causes the at least one processor to perform a memory efficient neural network training method, the method comprising:
(a) performing a forward pass by inputting a batch of training data to a neural network;
(b) determining a loss from an output of the neural network resulting from the forward pass; and
(c) performing back propagation on the neural network, wherein performing the back propagation comprises:
(i) for each layer of the neural network:
(A) determining a gradient and/or optimizer state for the layer of the neural network; and
(B) compressing the gradient and/or optimizer state by performing a random down-projection on the gradient;
(ii) following determining and down projecting the gradients and/or optimizer states for the layers of the neural network, decompressing the gradients and/or optimizer states based on the gradients; and
(iii) updating weights of the neural network based on the decompressed gradients and/or optimizer states, wherein a different random down-projection is used for each layer during the back propagation.

20. The at least one non-transitory computer readable medium of claim 19, wherein the updating of the weights is performed on a per layer basis.
